(19) United States
(12) Patent Application Publication
(10) Pub. No.: US 2026/0151731 A1
(43) Pub. Date: Jun. 4, 2026

(54) CARBON DIOXIDE PIPELINE ADDITIVES

(71) Applicant: ChampionX LLC, Sugar Land, TX (US)

(72) Inventor: Jeremy Moloney, Katy, TX (US)

(21) Appl. No.: 19/354,638

(22) Filed: Oct. 9, 2025

Related U.S. Application Data
(60) Provisional application No. 63/705,790, filed on Oct. 10, 2024.

(51) Int. Cl. B01D 53/46; B01D 53/28

(52) U.S. Cl. CPC B01D 53/46; B01D 53/28; B01D 2256/22; B01D 2257/104; B01D 2257/302; B01D 2257/304; B01D 2257/404; B01D 2257/80; B01D 2259/124; B01D 2259/4525

(57) ABSTRACT

A formulation for preventing or reducing the effect of impurities contained in the carbon dioxide of a carbon dioxide pipeline. The formulation can include an additive that can adsorb, absorb, react with, complex with, or bind with impurities in the carbon dioxide pipelines to render the impurity in another form, compound, or otherwise unavailable for interaction with the pipeline materials. The additive can be a dehydrating agent, an oxygen scavenger, a hydrogen sulfide scavenger, a sulfur oxides removal agent, a nitrogen oxides removal agent, or combinations thereof.

### CROSS REFERENCE TO RELATED APPLICATIONS

This application is a non-provisional patent application claiming the benefit of, and priority to, U.S. Provisional Patent Application No. 63/705,790 , filed Oct. 10, 2024, which is incorporated by reference herein in its entirety.

### FIELD OF THE DISCLOSURE

The present disclosure generally relates to carbon dioxide pipelines, and more particularly to the impurities contained in the carbon dioxide that is transferred through carbon dioxide pipelines.

### BACKGROUND

Carbon dioxide can be transported from one location to another in a carbon dioxide pipeline.

Carbon dioxide (CO₂) in gas phase is generally compressed and cooled to a temperature in a range of from −56.6° C. to 31° C. and a pressure in a range of from 0.52 MPag to 7.4 MPag to produce liquid carbon dioxide. For transport of liquid carbon dioxide pipeline, temperature and pressure can be, for example, in a range of 7.58 MPag to 15.17 MPag and 15° C. to 32° C.

Carbon dioxide pipelines have gained significant importance due to their pivotal role in mitigating climate change, enhancing industrial processes, and ensuring compliance with environmental regulations. The growth of these pipelines is largely driven by advancements in carbon capture and storage (CCS) technologies, supportive government policies, and the increasing needs of various industries.

One of the primary reasons for the importance of carbon dioxide pipelines is their role in CCS technologies that reduce greenhouse gas emissions. Carbon dioxide pipelines facilitate the transportation of captured carbon dioxide from industrial sources, such as power plants and manufacturing facilities, to storage sites where it can be sequestered deep underground or to other sites where carbon dioxide is used for other purposes. By doing so, carbon dioxide pipelines help prevent large quantities of carbon dioxide from entering the atmosphere, thus contributing to global efforts to combat climate change.

In carbon dioxide pipelines, several acids including sulfuric acid, sulfurous acid, nitric acid, and nitrous acid can be present. These acids can cause significant problems, particularly corrosion, which can compromise the integrity and safety of the pipelines. These acids are highly corrosive and they can cause extensive corrosion of the pipeline materials, especially metals like steel. Moreover, these acids can accelerate the degradation of protective coatings and liners inside the pipeline, reducing their lifespan and effectiveness.

The presence of acids and oxygen in carbon dioxide pipelines can lead to electrochemical reactions that result in the oxidation of metals, producing metal oxides and other compounds that weaken the pipeline material. These acids can also lead to stress corrosion cracking, where the combined effect of tensile stress and a corrosive environment causes the pipeline to crack and fail.

Some solutions to address corrosion issues include using corrosion resistant alloys and composites materials; however, these materials of construction come with a high capital cost. Other solution may include the use of corrosion inhibitors; however, not only can these solutions be expensive, corrosion inhibitors can be targeted to one type of corrosion caused by one mechanism or acid but not another. Other solutions include mechanical removal of corrosive materials; however, these solutions often involve large capital expenditures on equipment, as well as ongoing maintenance cost for operation of the equipment.

### SUMMARY

A method includes: introducing a formulation including an additive to a carbon dioxide pipeline including carbon dioxide, wherein the additive includes a dehydrating agent, an oxygen scavenger, a hydrogen sulfide scavenger, a sulfur oxides removal agent, a nitrogen oxides removal agent, or combinations thereof.

A formulation includes an additive for a carbon dioxide pipeline, wherein the additive includes a dehydrating agent, an oxygen scavenger, a hydrogen sulfide scavenger, a sulfur oxides removal agent, a nitrogen oxides removal agent, or combinations thereof.

A carbon dioxide pipeline includes: a pipeline; carbon dioxide contained in the pipeline; and a formulation including an additive for the carbon dioxide contained in the pipeline, wherein the additive includes a dehydrating agent, an oxygen scavenger, a hydrogen sulfide scavenger, a sulfur oxides removal agent, a nitrogen oxides removal agent, or combinations thereof.

A system includes: a pipeline containing carbon dioxide and an impurity; and an impurity removal unit coupled to the pipeline, wherein the impurity removal unit receives at last a portion of the carbon dioxide from a first location on the pipeline, removes the impurity or converts the impurity to a compound that can be removed by the impurity removal unit, and sends an impurity depleted carbon dioxide to a second location on the pipeline that is downstream of the first location.

Other technical features may be readily apparent to one skilled in the art from the following figures, descriptions, and claims.

### DETAILED DESCRIPTION

Disclosed are formulations having one or more additives that are introduced into the carbon dioxide in a carbon dioxide pipeline, to adsorb, absorb, react with, complex with, bind with, dissolve, or otherwise draw out impurities in the carbon dioxide pipelines to render the impurity in another form, converted to another compound, or otherwise unavailable for interaction with the pipeline materials. The formulations are generally compatible with the conditions of the carbon dioxide pipeline, for example, compatible with temperatures and pressures in which carbon dioxide is present in the gas phase, in the liquid phase, in the supercritical state, or in one or more of the gas phase, liquid phase, and supercritical state.

The additive may be formulated with a carrier liquid. There may be a single additive or a combination of additives within a single formulation, or there may be a combination of the same or different formations that can be introduced at separate locations in the pipeline. The order of which may be determined based on chemistry compatibility. If more than one additive is included in a formulation, the concentration of the additives in the formulation may be based on the concentration specific impurities being targeted in the carbon dioxide stream.

The additive in the formulation is dependent on the impurity encountered in the carbon dioxide of the pipeline, which can include water, hydrogen sulfide, oxygen, sulfur oxides, and nitrogen oxides. The formulation can include one or more additive selected from a dehydrating agent, an oxygen scavenger, a hydrogen sulfide scavenger, a sulfur oxides removal agent, a nitrogen oxides removal agent, or combinations thereof. The concentration of additive in the formulation can be in a range of from 20 wt % to 60 wt % based on a total weight of the formulation. In aspects, the additive is introduced at a concentration in the formulation that is sufficient for the additive to impurity mass ratio to be in a range of 1:1 to 10:1 based on the mass of additive and mass of impurity in the carbon dioxide in the pipeline.

The additive can be introduced to the carbon dioxide as a solid phase, liquid phase, gas phase, or combinations thereof. In some aspects of solid phase additive, the additive can be in the form of nanoparticles, functionalized nanoparticles, or both.

### Dehydrating Agents

The dehydrating agent can react with water in a carbon dioxide pipeline. The presence of water in carbon dioxide can form carbonic acid, which can cause corrosion in pipelines over time. Thus, removal of water can reduce or prevent the formation of carbonic acid.

The dehydrating agent can be introduced into a carbon dioxide pipeline in a solid phase, a liquid phase, a gas phase, or combinations thereof.

Dehydrating agents can include a solid desiccant, calcium chloride, phosphorus pentoxide, sodium sulfate, anhydrous magnesium sulfate, sulfuric acid, calcium oxide, barium oxide, an alkali-metal based compound, phosphorus oxychloride, phosphorous pentoxide, thionyl chloride, dimethyl sulfoxide, acetic anhydride, triethyl orthoformate, dimethylformamide, a brine, glycols, liquid desiccant, glycerol, an alcohol-based compound, acetic acid, sugar syrup, a carbodiimide-based compound, a perchloric acid-based compound, or combinations thereof.

### Solid Phase Dehydrating Agents

The dehydrating agent can take form of a solid, in a solid phase. The solid dehydrating agent can be introduced to the carbon dioxide as a pure solid into the carbon dioxide. Alternatively, the solid dehydrating agent can be introduced as a slurry or suspension in a carrier liquid described herein. Alternatively, the solid dehydrating agent can be soluble in a carrier liquid described herein and introduced as a solution of the dissolved solid in the carrier liquid.

Solid dehydrating agents can include a desiccant, calcium chloride, phosphorus pentoxide, sodium sulfate, anhydrous magnesium sulfate, sulfuric acid, calcium oxide, barium oxide, an alkali-metal based compound, a carbodiimide-based compound, or combinations thereof.

Desiccants are solid granules or pellets of a material that adsorbs water molecules. Examples of desiccant are silica gel, molecular sieve, and activated alumina. Silica gel can be in the form of granules or pellets of an amorphous and porous silica. Silica gel granules and pellets can have a high surface area for adsorption of water molecules. Molecular sieve suitable for use in this disclosure is a crystalline and porous aluminosilicate having a uniform pore size suitable for adsorption of water molecules. Activated alumina can be in the form of granules or pellets with a high surface area, that can adsorb water molecules. Water molecules are rendered unavailable for interacting with the pipeline materials after adsorption onto the surfaces of the desiccant.

Calcium chloride is highly hygroscopic and can absorb water molecules. Water molecules are rendered unavailable for interacting with the pipeline materials after adsorption onto the surfaces of the calcium chloride.

Phosphorus pentoxide can react with water to form phosphoric acid. The reaction thus removes water because the water molecules are converted into phosphoric acid by the reaction with phosphorus pentoxide.

Sodium sulfate can bind with water molecules to form sodium sulfate hydrates. With the water molecules bound to sodium sulfate, the water molecules are unavailable for interacting with the pipeline materials.

Anhydrous magnesium sulfate binds with water molecules to form magnesium sulfate hydrates. With the water molecules bound to magnesium sulfate, the water molecules are unavailable for interacting with the pipeline materials.

Solid sulfuric acid is highly hygroscopic and can absorb water from the carbon dioxide. The absorption of the water molecules into the sulfuric acid renders the water molecules unavailable for interacting with the pipeline materials.

Calcium oxide can react with water to form calcium hydroxide. The reaction converts water molecules into another compound, removing the water molecules from the carbon dioxide.

Barium oxide can react with water to form barium hydroxide. The reaction converts water molecules into another compound, removing the water molecules from the carbon dioxide.

Alkali-metal based compounds can dissolve in droplets or accumulations of water that is in the carbon dioxide. Examples of alkali-metal based compounds are sodium hydroxide and potassium hydroxide.

Carbodiimide-based compounds can be added as solid phase to carbon dioxide, to react with water, which forms a urea derivative. An example of a carbodiimide-based compound is dichlorohexylcarbodiimide. The reaction bonds with water molecules, removing the water molecules from the carbon dioxide.

Liquid phase dehydrating agents

The dehydrating agent can take form of a liquid. The liquid can be introduced to the carbon dioxide as a pure liquid into the carbon dioxide. Alternatively, the additive liquid can be introduced as a solution or mixture of the additive liquid in a carrier liquid described herein.

Liquid phase dehydrating agents can include sulfuric acid, phosphorus oxychloride, phosphorous pentoxide, thionyl chloride, dimethyl sulfoxide, acetic anhydride, triethyl orthoformate, dimethylformamide, a brine, glycols, liquid desiccant, glycerol, an alcohol-based compound, acetic acid, sugar syrup, a carbodiimide-based compound, a perchloric acid-based compound, or combinations thereof.

Liquid sulfuric acid is highly hygroscopic and can absorb water from the carbon dioxide. The absorption of the water molecules into the sulfuric acid renders the water molecules unavailable for interacting with the pipeline materials.

Liquid phosphorus oxychloride can react with water to form phosphoric acid and hydrochloric acid. The reaction converts water molecules into another compound, removing the water molecules from the carbon dioxide.

Liquid phosphorus pentoxide can react with water to form phosphoric acid. The reaction converts water molecules into another compound, removing the water molecules from the carbon dioxide.

Liquid thionyl chloride can react with water to form sulfur dioxide and hydrochloric acid. The reaction converts water molecules into another compound, removing the water molecules from the carbon dioxide.

Liquid dimethyl sulfoxide (DMSO) has a high affinity for water and can dissolve water. Droplets of DMSO in the carbon dioxide can function to capture and dissolve water molecules in the DMSO droplet while the DMSO is in the carbon dioxide, taking the water molecules out of the carbon dioxide.

Liquid acetic anhydride can react with water to form acetic acid. The reaction converts water molecules into another compound, removing the water molecules from the carbon dioxide.

Liquid triethyl orthoformate can react with water to form ethanol and formic acid derivatives. The reaction converts water molecules into another compound, removing the water molecules from the carbon dioxide.

Liquid dimethylformamide (DMF) can absorb water and form stable hydrate complexes. The absorption of water into the DMF removes the water molecules from the carbon dioxide, and the formation of hydrates binds water molecules to the DMF, rendering the water molecules unavailable for interaction with the pipeline materials.

A brine, a solution of salt in water (e.g., a calcium chloride brine), can attract water molecules in the carbon dioxide to droplets of the brine in the carbon dioxide, due to solubility gradients between the brine and carbon dioxide. The brine uses the water molecules to dissolve the salt(s) in the brine, effectively removing the water molecules that pass into the brine from the carbon dioxide in the pipeline.

Liquid phase glycols include ethylene glycol, diethylene glycol, triethylene glycol, polyethylene glycol, or combinations thereof. The glycols absorb water from the carbon dioxide. The absorption of the water molecules into the glycol renders the water molecules unavailable for interacting with the pipeline materials.

Liquid desiccant can absorb water molecules from the carbon dioxide. An example of liquid desiccant is lithium chloride solution. The absorption of the water molecules into the liquid desiccant renders the water molecules unavailable for interacting with the pipeline materials.

Liquid glycerol (glycerin) can absorb water molecules from the carbon dioxide. The absorption of the water molecules into the glycerol renders the water molecules unavailable for interacting with the pipeline materials.

Alcohol-based compounds can draw water molecules out of the carbon dioxide. Example of an alcohol-based compounds are methanol and ethanol.

Acetic acid can draw water molecules out of the carbon dioxide.

Sugar syrup can draw water molecules out of the carbon dioxide.

Carbodiimide-based compounds can be added as liquid phase to carbon dioxide, to react with water, which forms a urea derivative. An example of a carbodiimide-based compound is dichlorohexylcarbodiimide. The reaction bonds with water molecules, removing the water molecules from the carbon dioxide.

Perchloric acid-based compounds can function as proton donors, donating a hydrogen ion to a water molecule. The proton donation converts the water molecule to hydronium ion, effectively removing water molecules from the carbon dioxide.

### Oxygen Scavengers

Oxygen scavengers can react with oxygen in a carbon dioxide pipeline. The presence of oxygen and water can accelerate the oxidative corrosion of metals by forming rust (iron oxides and hydroxides in the case of iron or steel pipelines). Thus, removal of oxygen can reduce or prevent oxidative corrosion of the materials of the carbon dioxide pipeline.

The oxygen scavenger can include a sulfite, a phosphite, hydrazine, ascorbic acid or a derivative thereof, an iron powder, a tannin, an enzyme-based compound, sodium erythorbate, sulfur dioxide, diethyl hydroxylamine, carbohydrazide, methyl ethyl ketoxime, a copper-based compound, a phenol-containing compound, or combinations thereof.

Sulfites can react with oxygen in the carbon dioxide to form sulfates. Examples of sulfites include sodium sulfite, sodium bisulfite, potassium metabisulfite, ammonium bisulfite, and combinations thereof. The reaction converts oxygen molecules into another compound, removing the oxygen molecules from the carbon dioxide. The sulfates can then bind with water molecules to form sulfate hydrates. With the water molecules bound to sulfates, the water molecules are unavailable for interacting with the pipeline materials. Use of sulfites is an example of a dual-purpose additive that can address two or more impurities, with the example being that oxygen can be removed by reaction with sulfites to form sulfates, and then the sulfates can bind with water molecules to render the water molecules unavailable for interacting with the pipeline materials.

Phosphites can react with oxygen in the carbon dioxide to form phosphates. Examples of phosphites include sodium phosphite, ammonium phosphite, triethyl phosphite, tributyl phosphite, triphenyl phosphite, and combinations thereof. The reaction converts oxygen molecules into another compound, removing the oxygen molecules from the carbon dioxide. The phosphites can then bind with water molecules to form phosphate hydrates. With the water molecules bound to phosphates, the water molecules are unavailable for interacting with the pipeline materials. Use of phosphites is an example of a dual-purpose additive that can address two or more impurities, with the example being that oxygen can be removed by reaction with phosphites to form phosphates, and then the phosphates can bind with water molecules to render the water molecules unavailable for interacting with the pipeline materials.

Hydrazine can react with oxygen in the carbon dioxide to form nitrogen and water. The reaction converts oxygen molecules into nitrogen and water, removing the oxygen molecules from the carbon dioxide. Because water is formed, hydrazine is an additive that can be used in combination with a dehydrating agent additive to address the water that is formed. For example, the formulation can contain both a dehydrating agent and hydrazine, introduced at the same location in the pipeline. Alternatively, a first formulation containing hydrazine can be introduced into a first location on the pipeline, and a second formation containing a dehydrating agent can be introduced into a second location on the pipeline that is downstream of the first location. As discussed below, hydrazine can also be used to react with nitrogen oxides, and can be a dual-purpose additive for removing both oxygen impurity and nitrogen oxides impurities.

Ascorbic acid or derivatives thereof can react with oxygen to form dehydroascorbic acid. The reaction converts oxygen molecules into another compound, removing the oxygen molecules from the carbon dioxide. Examples of derivatives of ascorbic acid include ascorbyl esters and ascorbyl palmitate.

Iron powder can be introduced to the carbon dioxide in the pipeline to react with oxygen to form iron oxides. The reaction converts oxygen molecules into another compound, removing the oxygen molecules from the carbon dioxide.

Tannins are polyphenol compounds that can be derived from natural sources such as plants. Thus, tannins are a natural, non-synthetic option for removing oxygen from carbon dioxide. The polyphenolic compounds can react with or complex with oxygen in the carbon dioxide pipeline. The reaction and/or complexation converts or traps the oxygen atoms or molecules, effectively removing the oxygen from the carbon dioxide.

Enzyme based compounds can be used to consume oxygen present in the carbon dioxide. Examples of enzyme-based compounds are a combination of glucose oxidase enzyme with glucose, which can consume oxygen present in carbon dioxide by the oxidation of glucose with oxygen in presence of the glucose oxidase (acting as a catalyst), forming gluconic acid and hydrogen peroxide. The reaction converts oxygen molecules into another compound, removing the oxygen molecules from the carbon dioxide.

Sodium erythorbate reacts with oxygen to form dehydroerythorbic acid. The reaction converts oxygen molecules into another compound, removing the oxygen molecules from the carbon dioxide.

Sulfur dioxide reacts with oxygen to form sulfates and water. The reaction converts oxygen molecules into another compound, removing the oxygen molecules from the carbon dioxide. However, the reaction produces water. The produced sulfates can then bind with water molecules to form sulfate hydrates. With the water molecules bound to sulfates, the water molecules are unavailable for interacting with the pipeline materials. Use of sulfur dioxide is an example of a dual-purpose additive that can address two or more impurities, with the example being that oxygen can be removed by reaction with sulfur dioxide to form sulfates, and then the sulfates can bind with formed water molecules to render the water molecules unavailable for interacting with the pipeline materials. The water molecules can also be addressed by using a dehydrating agent disclosed herein. For example, the formulation can contain both a dehydrating agent and sulfur dioxide, introduced at the same location in the pipeline. Alternatively, a first formulation containing sulfur dioxide can be introduced into a first location on the pipeline, and a second formation containing a dehydrating agent can be introduced into a second location on the pipeline that is downstream of the first location.

Diethyl hydroxylamine (DEHA) can react with oxygen in the carbon dioxide to form water and nitrogen. The reaction converts oxygen molecules into another compound, removing the oxygen molecules from the carbon dioxide. However, the reaction produces water. The water molecules can be addressed by using a dehydrating agent disclosed herein in combination with DEHA. For example, the formulation can contain both a dehydrating agent and DEHA, introduced at the same location in the pipeline. Alternatively, a first formulation containing DEHA can be introduced into a first location on the pipeline, and a second formation containing a dehydrating agent can be introduced into a second location on the pipeline that is downstream of the first location.

Carbohydrazide can react with oxygen to form carbon dioxide, nitrogen, and water. The carbon dioxide can become part of the carbon dioxide that is being transported in the pipeline. The reaction converts oxygen molecules into another compound, removing the oxygen molecules from the carbon dioxide. However, the reaction produces water. The water molecules can be addressed by using a dehydrating agent disclosed herein in combination with carbohydrazide. For example, the formulation can contain both a dehydrating agent and carbohydrazide, introduced at the same location in the pipeline. Alternatively, a first formulation containing carbohydrazide can be introduced into a first location on the pipeline, and a second formation containing a dehydrating agent can be introduced into a second location on the pipeline that is downstream of the first location.

Methyl ethyl ketoxime can react with oxygen to produce various products that are stable in a carbon dioxide. The reaction converts oxygen molecules into another compound, removing the oxygen molecules from the carbon dioxide.

Copper-based compounds can react with oxygen to form a copper oxide. The reaction converts oxygen to another compound, removing the oxygen from the carbon dioxide.

Phenol-containing compounds can react with oxygen via oxidation reactions, functioning as antioxidants for other compounds in the carbon dioxide. The reaction converts oxygen molecules into another compound, removing the oxygen molecules from the carbon dioxide. Examples of phenol-containing compounds include phenol, hydroquinone, tertiary butylhydroquinone (TBHQ), butylated hydroxytoluene, 2,6-di-tert-butylphenol (BHT-like antioxidants), or a combination thereof.

### Hydrogen Sulfide Scavengers

The presence of hydrogen sulfide and water can form sulfuric acid. Sulfuric acid can lead to severe corrosion problems in the pipeline materials of a carbon dioxide pipeline.

The hydrogen sulfide scavenger can include a metal-based compound, nitrite-based compounds, an amine, an ammonium-based compound, caustic-based compounds, a hydrogen sulfide oxidizing agent, a triazine-based compound, a calcium hydroxide, calcium carbonate, an aldehyde-based compound, acrolein, a chelating agent-based compound, a thiol-functionalized polymer, an ionic liquid, or combinations thereof.

Metal-based compounds can react with hydrogen sulfide. Examples of metal-based compounds include an iron salt, an iron oxide, a zinc-based compound, or a combination thereof.

Iron salts can react with hydrogen sulfide to form iron sulfides. Examples of iron salts suitable for use in this disclosure include iron chloride and iron sulfate. The reaction converts hydrogen sulfide to another compound, effectively removing the hydrogen sulfide from the carbon dioxide.

Iron oxides can react with hydrogen sulfide to form solid or liquid byproducts. For example, iron oxide in the form of Fe₂O₃ can react with hydrogen sulfide to form iron sulfide and water. The reaction converts hydrogen sulfide to another compound, effectively removing the hydrogen sulfide from the carbon dioxide. However, water can be formed. This can be addressed by using iron oxides in combination with a dehydrating agent. For example, the formulation can contain both a dehydrating agent and iron oxide, introduced at the same location in the pipeline. Alternatively, a first formulation containing iron oxide can be introduced into a first location on the pipeline, and a second formation containing a dehydrating agent can be introduced into a second location on the pipeline that is downstream of the first location.

Zinc-based compounds can react with hydrogen sulfide to form zinc sulfide. The reaction converts hydrogen sulfide to other compounds, effectively removing the hydrogen sulfide from the carbon dioxide. An example of a zinc-based compound is zinc oxide. Zinc oxide can react with hydrogen sulfide to form zinc sulfite and water. The reaction converts hydrogen sulfide molecules into another compound, removing the hydrogen sulfide molecules from the carbon dioxide. Additionally, the zinc sulfite can react with any oxygen in the carbon dioxide to form zinc sulfate. The produced sulfates can then bind with water molecules to form sulfate hydrates. With the water molecules bound to sulfates, the water molecules are unavailable for interacting with the pipeline materials. Thus, zinc oxide is a triple-purpose additive, potentially addressing hydrogen sulfide impurity, oxygen impurity, and water impurity in the carbon dioxide in the pipeline.

Nitrites can react with oxygen in the carbon dioxide to form nitrates. Examples of nitrites include sodium nitrite, ammonium nitrite, and combinations thereof. The reaction converts oxygen molecules into another compound, removing the oxygen molecules from the carbon dioxide. The nitrates can then bind with water molecules to form nitrate hydrates. With the water molecules bound to nitrates, the water molecules are unavailable for interacting with the pipeline materials. Use of nitrites is an example of a dual-purpose additive that can address two or more impurities, with the example being that oxygen can be removed by reaction with nitrites to form nitrates, and then the nitrates can bind with water molecules to render the water molecules unavailable for interacting with the pipeline materials.

Amines can be reactive amines and complexation amines.

Reactive amines can react with hydrogen sulfide to form ammonium salts. Examples of amines suitable for this disclosure include monoethanolamine (MEA), diethanolamine (DEA), methyldiethanolamine (MDEA), and dibutylamine. The reaction converts hydrogen sulfide to another compound, effectively removing the hydrogen sulfide from the carbon dioxide.

Complexation amines can complex with hydrogen sulfide. An example of a complexation amine is hexamethyltetraamine (HMTA). A hexamethyltetraamine (HMTA) can form a complex with hydrogen sulfide molecule, effectively preventing the hydrogen sulfide from interacting with the materials of the carbon dioxide pipeline.

Ammonium-based compounds can react with hydrogen sulfide to from ammonium sulfides. Examples of ammonium-based compounds include ammonium hydroxide and ammonium carbonate. Ammonium hydroxide can react with hydrogen sulfide to produce ammonium sulfide and/or ammonium bisulfide with water. Ammonium carbonate can react with hydrogen sulfide to produce ammonium sulfide, carbon dioxide, and water. The reaction converts hydrogen sulfide to other compounds, effectively removing the hydrogen sulfide from the carbon dioxide. However, water can be formed. This can be addressed by using ammonium-based compounds in combination with a dehydrating agent. For example, the formulation can contain both a dehydrating agent and ammonium-based compound, introduced at the same location in the pipeline. Alternatively, a first formulation containing ammonium-based compound can be introduced into a first location on the pipeline, and a second formation containing a dehydrating agent can be introduced into a second location on the pipeline that is downstream of the first location.

Caustic-based compounds include sodium hydroxide and potassium hydroxide.

Sodium hydroxide (also referred to as caustic soda) can react with hydrogen sulfide to form sodium sulfide and sodium bisulfide, along with water. The reaction converts hydrogen sulfide to other compounds, effectively removing the hydrogen sulfide from the carbon dioxide. However, water can be formed. This can be addressed by using sodium hydroxide in combination with a dehydrating agent. For example, the formulation can contain both a dehydrating agent and sodium hydroxide, introduced at the same location in the pipeline. Alternatively, a first formulation containing sodium hydroxide can be introduced into a first location on the pipeline, and a second formation containing a dehydrating agent can be introduced into a second location on the pipeline that is downstream of the first location.

Sodium carbonate can react with hydrogen sulfide to form sodium sulfite and sodium bicarbonate, along with water. The reaction converts hydrogen sulfide to other compounds, effectively removing the hydrogen sulfide from the carbon dioxide. Additionally, the sodium sulfite can react with any oxygen in the carbon dioxide to form sodium sulfate. Thus, sodium carbonate is a dual-purpose additive, potentially addressing both hydrogen sulfide impurity and oxygen impurity in the carbon dioxide in the pipeline. However, water can be formed. This can be addressed by using sodium carbonate in combination with a dehydrating agent. For example, the formulation can contain both a dehydrating agent and sodium carbonate, introduced at the same location in the pipeline. Alternatively, a first formulation containing sodium carbonate can be introduced into a first location on the pipeline, and a second formation containing a dehydrating agent can be introduced into a second location on the pipeline that is downstream of the first location.

Hydrogen sulfide oxidizing agents can react with hydrogen sulfide to produce elemental sulfur or sulfuric acid. Examples of oxidizing agents are peroxide-based compounds such as hydrogen peroxide, and chlorine. Chlorine can react with hydrogen sulfide to produce hydrochloric acid. The reaction converts hydrogen sulfide to other compounds, effectively removing the hydrogen sulfide from the carbon dioxide.

Triazine-based compounds can react with hydrogen sulfide to form a thiol-containing compound. Examples of triazine compounds include hexhydro-1,3,5-triazine, methyl-1,3,5-triazine-2,4,6-trione, and hexahydro-1,3,5-tris(hydroxyethyl)-s-triazine (THEED). The reaction converts hydrogen sulfide to other compounds, effectively removing the hydrogen sulfide from the carbon dioxide. The thiol-containing products can be easily separated from liquid or gaseous carbon dioxide.

Calcium hydroxide can react with hydrogen sulfide to form calcium sulfide and water. The reaction converts hydrogen sulfide molecules into another compound, removing the hydrogen sulfide molecules from the carbon dioxide. Because water is formed in the reaction of calcium hydroxide and hydrogen sulfide, this can be addressed by using calcium hydroxide in combination with a dehydrating agent. For example, the formulation can contain both a dehydrating agent and calcium hydroxide, introduced at the same location in the pipeline. Alternatively, a first formulation containing calcium hydroxide can be introduced into a first location on the pipeline, and a second formation containing a dehydrating agent can be introduced into a second location on the pipeline that is downstream of the first location.

Calcium carbonate can react with hydrogen sulfide to form calcium sulfide and carbon dioxide. The reaction converts hydrogen sulfide molecules into another compound, removing the hydrogen sulfide molecules from the carbon dioxide.

Aldehyde-based compounds can react with hydrogen sulfide to form a thiol adduct. The reaction converts hydrogen sulfide molecules into another compound, removing the hydrogen sulfide molecules from the carbon dioxide. An example of an aldehyde is formaldehyde, glutaraldehyde, derivatives of formaldehyde, derivatives of glutaraldehyde, and combinations thereof.

Acrolein can react with hydrogen sulfide to form a thioether or a thiol adduct. The reaction that forms a thioether converts hydrogen sulfide molecules into another compound, removing the hydrogen sulfide molecules from the carbon dioxide. The formation of an adduct effectively renders the hydrogen sulfide from interacting with the materials of the carbon dioxide pipeline.

Chelating agent-based compounds can be a complex of a metal with chelated with a molecule, and the complex can react with hydrogen sulfide, oxidizing hydrogen sulfide to elemental sulfur. The reaction converts hydrogen sulfide molecules into another compound, removing the hydrogen sulfide molecules from the carbon dioxide. Examples of a chelating agent-based compounds are ethylenediaminetetraacetic acid (EDTA) complexed with a metal such as iron, nitrilotriacetic acid complexed with a metal such as iron, or combinations thereof.

A thiol-functionalized polymer can convert hydrogen sulfide into a sulfur compound that is anchored to the polymer structure, such as through adsorption, reaction, or both of hydrogen sulfide with or onto the thiol-functionalized polymer. The thiol group can function as the site on the polymer at or near where the hydrogen sulfide molecule is captured. Examples of thiol-functionalized polymers include thiolated chitosan, thiolated polyethylene glycol, thiolated polyacrylic acid, thiolated polyglycidol, thiolated dextran, thiolated polyurethane, thiolated poly(2-oxazoline), thiolated polynorbornene, thiolated polyalkylsiloxane, thiolated alginate, and combinations thereof.

An ionic liquid can absorb, either via physical absorption or chemical absorption, hydrogen sulfide. Hydrogen sulfide effectively can be trapped within the non-volatile liquid molecules of the ionic liquid. Examples of ionic liquids include 1-ethyl-3-methylimidazolium acetate ([Emim][Ac]), 1-butyl-3-methylimidazolium bis(trifluoromethylsulfonyl)imide ([Bmim][Tf₂N]), 1-butyl-3-methylimidazolium chloride ([Bmim][Cl]), 1-butyl-3-methylimidazolium tetrafluoroborate ([Bmim][BF₄]), 1-butyl-3-methylimidazolium hexafluorophosphate ([Bmim][PF₆]), 1-(2-hydroxyethyl)-3-methylimidazolium tetrafluoroborate ([HOEtmim][BF₄]), 1-ethyl-3-methylimidazolium dicyanamide ([Emim][DCA]), 1,1,3,3-tetramethylguanidinium triflate ([TMG][TfO]), diallyldimethylammonium bis(trifluoromethylsulfonyl)imide ([DADMA][Tf2N]), and combinations thereof.

### Sulfur Oxides Removal Agents

The presence of sulfur oxides in a carbon dioxide pipeline can form highly corrosive acids. For example, the presence of sulfur dioxide and water can form sulfurous acid, which is highly corrosive to metals used in carbon dioxide pipelines.

The sulfur oxides removal agent can include lime-based compounds, sodium-based compounds, ammonia-based compounds, magnesium-based compounds, metal-oxide compounds, carbon-based materials, chelating agent-based compounds, organic amine-based compounds, catalyst-based compounds, or combinations thereof.

Lime-based compounds can include calcium carbonate, calcium hydroxide, and calcium oxides.

Calcium carbonate can react with sulfur dioxide to form calcium sulfite. The reaction converts sulfur dioxide molecules into another compound, removing the sulfur dioxide molecules from the carbon dioxide. Additionally, the calcium sulfite can react with any oxygen in the carbon dioxide to form calcium sulfate. Thus, calcium carbonate is a dual-purpose additive, potentially addressing both sulfur dioxide impurity and oxygen impurity in the carbon dioxide in the pipeline.

Calcium hydroxide can react with sulfur dioxide to form calcium sulfite and water. The reaction converts sulfur dioxide molecules into another compound, removing the sulfur dioxide molecules from the carbon dioxide. Additionally, the calcium sulfite can react with any oxygen in the carbon dioxide to form calcium sulfate. The produced sulfates can then bind with water molecules to form sulfate hydrates. With the water molecules bound to sulfates, the water molecules are unavailable for interacting with the pipeline materials. Thus, calcium hydroxide is a triple-purpose additive, potentially addressing sulfur dioxide impurity, oxygen impurity, and water impurity in the carbon dioxide in the pipeline. Because water is formed in the reaction of calcium hydroxide and sulfur dioxide, this can be addressed by using calcium hydroxide in combination with a dehydrating agent. For example, the formulation can contain both a dehydrating agent and calcium hydroxide, introduced at the same location in the pipeline. Alternatively, a first formulation containing calcium hydroxide can be introduced into a first location on the pipeline, and a second formation containing a dehydrating agent can be introduced into a second location on the pipeline that is downstream of the first location.

Calcium oxide can react with sulfur oxides to form calcium sulfites. The reaction converts sulfur dioxide molecules into another compound, removing the sulfur dioxide molecules from the carbon dioxide. Additionally, the calcium sulfite can react with any oxygen in the carbon dioxide to form calcium sulfate. The produced sulfates can then bind with water molecules to form calcium hydrates. With the water molecules bound to sulfates, the water molecules are unavailable for interacting with the pipeline materials. Thus, calcium oxide is a triple-purpose additive, potentially addressing sulfur dioxide impurity, oxygen impurity, and water impurity in the carbon dioxide in the pipeline.

Sodium-based compounds include sodium carbonate and sodium hydroxide.

Sodium carbonate can react with sulfur dioxide to form sodium sulfite. The reaction converts sulfur dioxide molecules into another compound, removing the sulfur dioxide molecules from the carbon dioxide. Additionally, the sodium sulfite can react with any oxygen in the carbon dioxide to form sodium sulfate. The produced sulfates can then bind with water molecules to form sulfate hydrates. With the water molecules bound to sulfates, the water molecules are unavailable for interacting with the pipeline materials. Thus, sodium carbonate is a triple-purpose additive, potentially addressing sulfur dioxide impurity, oxygen impurity, and water impurity in the carbon dioxide in the pipeline.

Sodium hydroxide can react with sulfur dioxide to form sodium sulfite and water. The reaction converts sulfur dioxide molecules into another compound, removing the sulfur dioxide molecules from the carbon dioxide. Additionally, the sodium sulfite can react with any oxygen in the carbon dioxide to form sodium sulfate. The produced sulfates can then bind with water molecules to form sulfate hydrates. With the water molecules bound to sulfates, the water molecules are unavailable for interacting with the pipeline materials. Thus, sodium hydroxide is a triple-purpose additive, potentially addressing sulfur dioxide impurity, oxygen impurity, and water impurity in the carbon dioxide in the pipeline. However, because water is formed in the reaction of sodium hydroxide and sulfur dioxide, this can be addressed by using sodium hydroxide in combination with a dehydrating agent. For example, the formulation can contain both a dehydrating agent and sodium hydroxide, introduced at the same location in the pipeline. Alternatively, a first formulation containing sodium hydroxide can be introduced into a first location on the pipeline, and a second formation containing a dehydrating agent can be introduced into a second location on the pipeline that is downstream of the first location.

Ammonia-based compounds include ammonium hydroxide and ammonia.

Ammonium hydroxide can react with sulfur dioxide to form ammonium sulfite or ammonium bisulfite, along with water. The reaction converts sulfur dioxide molecules into another compound, removing the sulfur dioxide molecules from the carbon dioxide. Additionally, the ammonium sulfite or ammonium bisulfite can react with any oxygen in the carbon dioxide to form ammonium sulfates. The produced sulfates can then bind with water molecules to form sulfate hydrates. With the water molecules bound to sulfates, the water molecules are unavailable for interacting with the pipeline materials. Thus, ammonia is a triple-purpose additive, potentially addressing sulfur dioxide impurity, oxygen impurity, and water impurity in the carbon dioxide in the pipeline. However, because water is formed in the reaction of ammonium hydroxide and sulfur dioxide, this can be addressed by using ammonium hydroxide in combination with a dehydrating agent. For example, the formulation can contain both a dehydrating agent and ammonium hydroxide, introduced at the same location in the pipeline. Alternatively, a first formulation containing ammonium hydroxide can be introduced into a first location on the pipeline, and a second formation containing a dehydrating agent can be introduced into a second location on the pipeline that is downstream of the first location.

Ammonia can react with sulfur dioxide and water to form ammonium sulfite or ammonium bisulfite. The reaction converts sulfur dioxide molecules and water molecules into other compounds, removing the sulfur dioxide and water molecules from the carbon dioxide. Additionally, the ammonium sulfite or ammonium bisulfite can react with any oxygen in the carbon dioxide to form ammonium sulfates. The produced sulfates can then bind with additional water molecules to form sulfate hydrates. With the water molecules bound to sulfates, the water molecules are unavailable for interacting with the pipeline materials. Thus, ammonia is a triple-purpose additive with enhanced water removal capability since two reactions in the chain of reaction remove water molecules, potentially addressing sulfur dioxide impurity, water impurity, and oxygen impurity in the carbon dioxide in the pipeline.

Magnesium-based compounds include magnesium hydroxide and magnesium oxide.

Magnesium hydroxide can react with sulfur dioxide to form magnesium sulfite and water. The reaction converts sulfur dioxide molecules into another compound, removing the sulfur dioxide molecules from the carbon dioxide. Additionally, the magnesium sulfite can react with any oxygen in the carbon dioxide to form ammonium sulfates. Thus, magnesium hydroxide is a dual-purpose additive, potentially addressing both sulfur dioxide impurity and oxygen impurity in the carbon dioxide in the pipeline. However, water is formed in the reaction of magnesium hydroxide and sulfur dioxide. This can be addressed by using magnesium hydroxide in combination with a dehydrating agent. For example, the formulation can contain both a dehydrating agent and magnesium hydroxide, introduced at the same location in the pipeline. Alternatively, a first formulation containing magnesium hydroxide can be introduced into a first location on the pipeline, and a second formation containing a dehydrating agent can be introduced into a second location on the pipeline that is downstream of the first location.

Magnesium oxide can react with sulfur oxides to form magnesium sulfate. The reaction converts sulfur dioxide molecules into another compound, removing the sulfur dioxide molecules from the carbon dioxide. Additionally, the produced sulfates can then bind with water molecules to form magnesium hydrates. With the water molecules bound to sulfates, the water molecules are unavailable for interacting with the pipeline materials. Thus, magnesium oxide is a dual-purpose additive, potentially addressing sulfur dioxide impurity and water impurity in the carbon dioxide in the pipeline.

Metal oxide compounds include an iron oxide and zine oxide.

Iron oxides can react with sulfur dioxide to form iron sulfates and sulfur trioxide. The reaction converts sulfur dioxide molecules and water molecules into other compounds, removing the sulfur dioxide and water molecules from the carbon dioxide. The produced sulfates can then bind with water molecules to form sulfate hydrates. With the water molecules bound to sulfates, the water molecules are unavailable for interacting with the pipeline materials. Thus, iron oxides are a dual-purpose additive potentially addressing sulfur dioxide impurity and water impurity in the carbon dioxide pipeline. However, the sulfur trioxide can react with water to form sulfuric acid, which is highly hygroscopic and can absorb water from the carbon dioxide. The absorption of the water molecules into the sulfuric acid renders the water molecules unavailable for interacting with the pipeline materials. Thus, iron oxides can be used in combination with a dehydrating agent to remove water molecules and prevent water molecules from reacting with the sulfur trioxide.

Zinc oxide can react with sulfur dioxide to form zinc sulfite. The reaction converts sulfur dioxide molecules into another compound, removing the sulfur dioxide molecules from the carbon dioxide. Additionally, the zinc sulfite can react with any oxygen in the carbon dioxide to form zinc sulfate. The produced sulfates can then bind with water molecules to form sulfate hydrates. With the water molecules bound to sulfates, the water molecules are unavailable for interacting with the pipeline materials. Thus, zinc oxide is a triple-purpose additive, potentially addressing sulfur dioxide impurity, oxygen impurity, and water impurity in the carbon dioxide in the pipeline.

Carbon-based materials can include activated carbon. Activated carbon can absorb sulfur oxides. The absorption of the sulfur oxide molecules into the activated carbon renders the sulfur oxide molecules unavailable for interacting with the pipeline materials.

Chelating agent-based compounds can be a complex of a metal with chelated with a molecule, and the complex can react with sulfur oxides, oxidizing the sulfur oxides to elemental sulfur. The reaction converts sulfur oxide molecules into another compound, removing the sulfur oxide molecules from the carbon dioxide. Examples of a chelating agent-based compounds are ethylenediaminetetraacetic acid (EDTA) complexed with a metal such as iron, nitrilotriacetic acid complexed with a metal such as iron, or combinations thereof.

Organic amine-based compounds can absorb sulfur oxides. The absorption of the sulfur oxide molecules by the organic amine-based compound renders the sulfur oxide molecules unavailable for interacting with the pipeline materials. Examples of organic amine-based compounds include methyl diethanolamine (MDEA), monoethanolamine (MEA), diethanolamine (DEA), and triethanolamine (TEA).

Catalyst-based compounds can oxidize sulfur oxide compounds to form sulfates. Examples of catalyst-based compounds are vanadium pentoxide and titanium dioxide. The produced sulfates can then bind with water molecules to form sulfate hydrates. With the water molecules bound to sulfates, the water molecules are unavailable for interacting with the pipeline materials. Thus, catalyst-based compounds can be a multi-purpose additive, potentially addressing sulfur dioxide impurity and water impurity in the carbon dioxide in the pipeline.

### Nitrogen Oxides Removal Agents

Nitrogen oxides and water can form nitric acid (HNO₃) and nitrous acid (HNO₂), for example, via the reaction: 2NO₂+H₂O=HNO₃+HNO₂. Nitric acid, in particular, is a strong acid and highly corrosive.

The nitrogen oxide removal agent can include metal oxide-based compounds, peroxide-based compounds, absorbents, sodium-based compounds, ammonia, urea, hydrazine, catalyst-based compounds, biological materials, or a combination thereof.

Metal oxide-based compounds can react with nitrogen dioxide to form a metal nitrate. The nitrates can then bind with water molecules to form nitrate hydrates. With the water molecules bound to nitrates, the water molecules are unavailable for interacting with the pipeline materials. Use of metal oxide-based compounds is an example of a dual-purpose additive that can address two or more impurities, with the example being that nitrogen oxides can be removed by reaction with metal oxide-based compounds to form metal nitrates, and then the nitrates can bind with water molecules to render the water molecules unavailable for interacting with the pipeline materials. The reaction converts nitrogen dioxide molecules into other compounds, removing the nitrogen dioxide molecules from the carbon dioxide. Nonlimiting examples of metal oxide-based compounds include iron oxide, copper oxide, and cobalt oxide.

Peroxide based-compounds can react with nitrogen oxides to form nitrates. The nitrates can then bind with water molecules to form nitrate hydrates. With the water molecules bound to nitrates, the water molecules are unavailable for interacting with the pipeline materials. Use of peroxide-based compounds is an example of a dual-purpose additive that can address two or more impurities, with the example being that nitrogen oxides can be removed by reaction with peroxide-based compounds to form nitrates, and then the nitrates can bind with water molecules to render the water molecules unavailable for interacting with the pipeline materials. The reaction converts nitrogen oxide molecules into other compounds, removing the nitrogen oxide molecules from the carbon dioxide. Nonlimiting examples of peroxide-based compounds include hydrogen peroxide.

Absorbents can absorb nitrogen oxides. Examples of absorbents include activated carbon and zeolites. The absorption of the nitrogen oxide molecules into the absorbent renders the nitrogen oxide molecules unavailable for interacting with the pipeline materials.

Sodium-based compounds include sodium carbonate and sodium hydroxide.

Sodium carbonate can react with nitrogen dioxide to form sodium nitrite. The reaction converts nitrogen dioxide molecules into another compound, removing the nitrogen dioxide molecules from the carbon dioxide. Additionally, the nitrogen sulfite can react with any oxygen in the carbon dioxide to form sodium nitrate. The produced nitrates can then bind with water molecules to form nitrate hydrates. With the water molecules bound to nitrates, the water molecules are unavailable for interacting with the pipeline materials. Thus, sodium carbonate is a triple-purpose additive, potentially addressing nitrogen dioxide impurity, oxygen impurity, and water impurity in the carbon dioxide in the pipeline.

Sodium hydroxide can react with nitrogen dioxide to form sodium nitrite and water. The reaction converts nitrogen dioxide molecules into another compound, removing the nitrogen dioxide molecules from the carbon dioxide. Additionally, the sodium nitrite can react with any oxygen in the carbon dioxide to form sodium nitrate. The produced nitrates can then bind with water molecules to form nitrate hydrates. With the water molecules bound to nitrates, the water molecules are unavailable for interacting with the pipeline materials. Thus, sodium hydroxide is a triple-purpose additive, potentially addressing nitrogen dioxide impurity, oxygen impurity, and water impurity in the carbon dioxide in the pipeline. However, because water is formed in the reaction of sodium hydroxide and nitrogen dioxide, this can be addressed by using sodium hydroxide in combination with a dehydrating agent. For example, the formulation can contain both a dehydrating agent and sodium hydroxide, introduced at the same location in the pipeline. Alternatively, a first formulation containing sodium hydroxide can be introduced into a first location on the pipeline, and a second formation containing a dehydrating agent can be introduced into a second location on the pipeline that is downstream of the first location.

Ammonia can react with nitrogen dioxide and oxygen to form nitrogen and water. The reaction converts nitrogen dioxide molecules and oxygen molecules into other compounds, removing the nitrogen dioxide and oxygen molecules from the carbon dioxide. Thus, ammonia is a dual-purpose additive, potentially addressing nitrogen dioxide impurity and oxygen impurity in the carbon dioxide in the pipeline. However, water is formed in the reaction. This can be addressed by using ammonia in combination with a dehydrating agent. For example, the formulation can contain both a dehydrating agent and ammonia, introduced at the same location in the pipeline. Alternatively, a first formulation containing ammonia can be introduced into a first location on the pipeline, and a second formation containing a dehydrating agent can be introduced into a second location on the pipeline that is downstream of the first location.

Urea can react with water to form ammonia and carbon dioxide. The produced ammonia can then react with nitrogen dioxide and oxygen to form nitrogen and water. The reaction converts water and nitrogen dioxide molecules into other compounds, removing the nitrogen dioxide and water molecules from the carbon dioxide. Thus, urea is a dual-purpose additive, potentially addressing nitrogen dioxide impurity and water impurity. However, water is produced. This can be addressed by using urea in combination with a dehydrating agent. For example, the formulation can contain both a dehydrating agent and urea, introduced at the same location in the pipeline. Alternatively, a first formulation containing urea can be introduced into a first location on the pipeline, and a second formation containing a dehydrating agent can be introduced into a second location on the pipeline that is downstream of the first location.

Hydrazine can react with nitrogen oxides to form nitrogen and water. Th reaction converts nitrogen oxides into other compounds, removing the nitrogen oxides from the carbon dioxide. However, water is produced. This can be addressed by using hydrazine in combination with a dehydrating agent. For example, the formulation can contain both a dehydrating agent and hydrazine, introduced at the same location in the pipeline. Alternatively, a first formulation containing hydrazine can be introduced into a first location on the pipeline, and a second formation containing a dehydrating agent can be introduced into a second location on the pipeline that is downstream of the first location. As discussed above, hydrazine can also be used to react with oxygen, and can be a dual-purpose additive for removing both oxygen impurity and nitrogen oxides impurities.

Catalyst-based compounds can oxidize nitrogen oxide compounds to form nitrates. Examples of catalyst-based compounds are vanadium pentoxide and titanium dioxide. The produced nitrates can then bind with water molecules to form nitrate hydrates. With the water molecules bound to nitrates, the water molecules are unavailable for interacting with the pipeline materials. Thus, catalyst-based compounds can be a multi-purpose additive, potentially addressing nitrogen oxide impurity and water impurity in the carbon dioxide in the pipeline.

Biological materials can remove nitrogen oxides by a process known as denitrification. Examples of biological materials include bacteria of the genera Alcaligenes, Bacillus, and Pseudomonas.

### Carrier Liquids

The formulation can include a carrier liquid. The carrier liquid can include an organic liquid, an inorganic liquid, or both. In aspects, the carrier liquid is a solvent for one or more of the additives disclosed herein. In some aspects, the carrier liquid can contain more than one additive described herein, where one or more additives are insoluble in the carrier liquid, one or more additives are soluble in the carrier liquid, or the carrier liquid includes a first additive that is soluble and a second additive that is insoluble in the carrier liquid. Examples of carrier liquid include water, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or any combination thereof.

The concentration of carrier liquid in the formulation can be in range of from 40 wt % to 80 wt % based on a total weight of the formulation.

### Surfactants

The formulation can include one or more surfactant. The surfactant can include an anionic surfactant (sulfate, sulfonate, and phosphate, carboxylate derivatives), a cationic surfactant (pH-dependent primary, secondary, or tertiary amines), a quaternary ammonium salt, a zwitterionic surfactant (betaines, phospholipids, tertiary amine oxides), a non-ionic surfactant, an ethoxylate, a fatty alcohol ethoxylate, a fatty acid ethoxylate, an alkyl phenol ethoxylate, or a combination thereof.

The concentration of surfactant in the formulation can be in a range of from greater than 0 wt % to 10 wt % based on a total weight of the formulation. In other aspects, no surfactant is present in the formulation, or surfactant is absent from the formulation.

### Drag Reducing Agent

In some aspects, the formulation can include any drag reducing agent known in the art with the aid of this disclosure. Nonlimiting examples of drag reducing agents include an oil-in-water emulsion containing a polymer, which comprises an aqueous phase comprising water and an oil phase comprising an oil-soluble polymer, an oil-miscible polymer, or a emulsifiable polymer. In aspects, the drag reducing agent can also include a polyglycerol, a polyglycerol derivative, a surfactant having a hydrophilic-lipophilic balance (HLB) of equal to or greater than about 8, or a combination thereof.

### pH Control Agent

In some aspects, the formulation can include any pH control agent known in the art with the aid of this disclosure. The pH control agent can be any chemical species or molecular entity that is soluble in water and has an available pair of electrons capable of forming a covalent bond with a proton (Bronsted base) or with the vacant orbital of some other species (Lewis base). In aspects, the pH control agent is a base. In additional or alternative aspects, the pH control agent can include an alkali metal hydroxide, an alkali metal carbonate, or a combination thereof. Nonlimiting examples of the pH control agent include Ca(OH)₂, Mg(OH)₂, Bi(OH)₃, Co(OH)₂, Pb(OH)₂, Ni(OH)₂, Ba(OH)₂ and Sr(OH)₂.

### Formulations

In aspects, the formulation can include the additive(s) in a range of from 20 wt % to 60 wt% and the carrier liquid in a range of from 40 wt % to 80 wt % based on a total weight of the formulation.

In other aspects, the formulation can include the additive(s) in a range of from 20 wt % to 60 wt %, the carrier liquid in a range of from 40 wt % to 80 wt %, and the surfactant is present in a range of from greater than 0 wt % to 10 wt % based on a total weight of the formulation.

### Method

The method disclosed herein includes introducing, injecting, adding, mixing, or otherwise combining a formulation comprising an additive to a carbon dioxide pipeline comprising carbon dioxide. In aspects, the formulation can be continuously or intermittently introduced into the pipeline. The formulation may be dosed into the pipeline by flowing the formulation for a period of time, stopping flow, and then again flowing the formulation.

One or more additives may be introduced in single formulation at a location on the pipeline. In other embodiments, there may be multiple introduction locations where more than one formulation is introduced. The order additive introduction may depend on chemistry compatibility, such as introducing additives that remove byproducts of a first additive downstream where the first additive is introduced.

The method can include passing the carbon dioxide through the pipeline before, during, after, or a combination of before, during, and after introducing. The method can further include passing a portion of the carbon dioxide from a first location in the carbon dioxide pipeline through an impurity removal unit to form an impurity depleted carbon dioxide; and flowing the impurity depleted carbon dioxide (or treated carbon dioxide) to a second location in the carbon dioxide pipeline, wherein the second location is downstream of the first location. Introducing can be performed with pumps.

### Pipeline and System

Disclosed is a carbon dioxide pipeline comprising: a pipeline; carbon dioxide contained in the pipeline; and an embodiment of one or more of the formulations disclosed herein. The pipeline can be formed of a material known in the art for transporting carbon dioxide, such as carbon steel, stainless steel, a polymer, or a combination thereof.

Also disclosed herein is system comprising a pipeline containing carbon dioxide and an impurity; and an impurity removal unit coupled to the pipeline, wherein the impurity removal unit receives at last a portion of the carbon dioxide from a first location on the pipeline, removes the impurity or converts the impurity to a compound that can be removed by the impurity removal unit, and sends an impurity depleted carbon dioxide to a second location on the pipeline that is downstream of the first location.

In aspects, the impurity removal unit can include a catalyst bed for removal of a nitrogen oxide compound from the carbon dioxide, a sulfur recovery unit for removal of hydrogen sulfide from the carbon dioxide, or both the catalyst be and the sulfur recovery unit.

The catalyst bed can include catalyst particles or pellets. The catalyst particles or pellets can be a metal (e.g., rhodium, palladium, platinum, or combinations thereof) supported on, impregnated into, bonded to the surface of silica, alumina, or silica-alumina particles or pellets. The treated carbon dioxide can be transferred to another location in the pipeline or to another carbon dioxide pipeline.

The sulfur recovery unit can be coupled with the carbon dioxide pipeline for conversion of hydrogen sulfide to elemental sulfur according to the Claus process known in the art. Because the Claus process operates at extremely high temperatures, the sulfur recovery unit can include compressors and cooler to compress and cool the treated carbon dioxide to again form carbon dioxide that can be transferred to another location in the pipeline or to another carbon dioxide pipeline.

### Additional Description

Aspect 1. A method comprising: introducing a formulation comprising an additive to a carbon dioxide pipeline comprising carbon dioxide, wherein the additive comprises a dehydrating agent, an oxygen scavenger, a hydrogen sulfide scavenger, a sulfur oxides removal agent, a nitrogen oxides removal agent, or combinations thereof.
Aspect 2. The method of Aspect 1, wherein the dehydrating agent comprises a solid desiccant, calcium chloride, phosphorus pentoxide, sodium sulfate, anhydrous magnesium sulfate, sulfuric acid, calcium oxide, barium oxide, an alkali-metal based compound, a carbodiimide-based compound, phosphorus oxychloride, phosphorous pentoxide, thionyl chloride, dimethyl sulfoxide, acetic anhydride, triethyl orthoformate, dimethylformamide, a brine, glycols, a liquid desiccant, glycerol, an alcohol-based compound, acetic acid, sugar syrup, a perchloric acid-based compound, or combinations thereof.
Aspect 3. The method of Aspect 1 or 2, wherein the dehydrating agent is introduced as a solid phase and comprises desiccant, calcium chloride, phosphorus pentoxide, sodium sulfate, anhydrous magnesium sulfate, sulfuric acid, calcium oxide, activated alumina, barium oxide, or combinations thereof.
Aspect 4. The method of any one of Aspects 1 to 3, wherein the dehydrating agent is introduced as a liquid phase and comprises sulfuric acid, phosphorus oxychloride, phosphorous pentoxide, thionyl chloride, dimethyl sulfoxide, acetic anhydride, triethyl orthoformate, dimethylformamide, a brine, glycols, liquid desiccant, glycerol, an alcohol-based compound, acetic acid, sugar syrup, a carbodiimide-based compound, a perchloric acid-based compound, or combinations thereof.
Aspect 5. The method of any one of Aspects 1 to 4, wherein the oxygen scavenger comprises a sulfite, a phosphite, hydrazine, ascorbic acid or a derivative thereof, an iron powder, a tannin, an enzyme-based compound, sodium erythorbate, sulfur dioxide, diethyl hydroxylamine, carbohydrazide, methyl ethyl ketoxime, a copper-based compound, a phenol-containing compound, or combinations thereof.

Aspect 6. The method of any one of Aspects 1 to 5, wherein the hydrogen sulfide scavenger comprises a metal-based compound, nitrite-based compounds, an amine, an ammonium-based compound, caustic-based compounds, a hydrogen sulfide oxidizing agent, a triazine-based compound, a calcium hydroxide, calcium carbonate, an aldehyde-based compound, acrolein, a chelating agent-based compounds, a thiol-functionalized polymer, an ionic liquid, or combinations thereof.

Aspect 7. The method of any one of Aspects 1 to 6, wherein the sulfur oxides removal agent comprises lime-based compounds, sodium-based compounds, ammonia-based compounds, magnesium-based compounds, metal-oxide compounds, carbon-based materials, chelating agent-based compounds, organic amine-based compounds, catalyst-based compounds, or combinations thereof.

Aspect 8. The method of any one of Aspects 1 to 7, wherein the nitrogen oxides removal agent comprises metal oxide-based compounds, peroxide-based compounds, absorbents, sodium-based compounds, ammonia, urea, hydrazine, catalyst-based compounds, biological materials, or combinations thereof.

Aspect 9. The method of any one of Aspects 1 to 8, wherein the formulation further comprises a carrier liquid comprising an organic liquid or an inorganic liquid.

Aspect 10. The method of Aspect 9, wherein the additive is present in the formulation in a range of from 20 wt % to 60 wt % and the carrier liquid is present in the formulation in a range of from 40 wt % to 80 wt % based on a total weight of the formulation.

Aspect 11. The method of Aspect 8 or 9, wherein the formulation further comprises a surfactant.

Aspect 12. The method of Aspect 11, wherein the additive is present in the formulation in a range of from 20 wt % to 60 wt %, the carrier liquid is present in the formulation in a range of from 40 wt % to 80 wt %, and the surfactant is present in a range of from greater than 0 wt % to 10 wt % based on a total weight of the formulation.

Aspect 13. The method of any one of Aspects 1 to 12, wherein the carbon dioxide pipeline comprises carbon dioxide and an impurity, wherein a mass ratio of the additive to the impurity after introducing is in a range of from 1:1 to 10:1 based on a mass of the additive and a mass of the impurity in the carbon dioxide that is contained in the carbon dioxide pipeline.

Aspect 14. The method of any one of Aspects 1 to 13, further comprising: passing a portion of the carbon dioxide from a first location in the carbon dioxide pipeline through an impurity removal unit to form an impurity depleted carbon dioxide; and flowing the impurity depleted carbon dioxide to a second location in the carbon dioxide pipeline, wherein the second location is downstream of the first location.
Aspect 15. The method of any one of Aspects 1 to 14, wherein the carbon dioxide pipeline comprises carbon dioxide and an impurity, wherein the impurity comprises water, hydrogen sulfide, oxygen, a sulfur oxide, a nitrogen oxide, or a combination thereof.
Aspect 16. The method of any one of Aspects 1 to 15, wherein the formulation further comprises a drag reducing agent, a pH control agent, or both.
Aspect 17. A formulation comprising an additive for a carbon dioxide pipeline, wherein the additive comprises a dehydrating agent, an oxygen scavenger, a hydrogen sulfide scavenger, a sulfur oxides removal agent, a nitrogen oxides removal agent, or combinations thereof.
Aspect 18. The formulation of Aspect 17, further comprising a carrier liquid.
Aspect 19. The formulation of Aspect 17 or 18, further comprising a surfactant.
Aspect 20. The formulation of any one of Aspects 17 to 19, further comprising a drag reducing agent, a pH control agent, or both.
Aspect 21. A carbon dioxide pipeline comprising: a pipeline; carbon dioxide contained in the pipeline; and a formulation comprising an additive for the carbon dioxide contained in the pipeline, wherein the additive comprises a dehydrating agent, an oxygen scavenger, a hydrogen sulfide scavenger, a sulfur oxides removal agent, a nitrogen oxides removal agent, or combinations thereof.
Aspect 22. The carbon dioxide pipeline of Aspect 21, wherein the formulation further comprises a carrier liquid.
Aspect 23. The carbon dioxide pipeline of Aspect 21 or 22, wherein the formulation further comprises a surfactant.
Aspect 24. The carbon dioxide pipeline of any one of Aspects 21 to 23, wherein the formulation further comprises a drag reducing agent, a pH control agent, or both.
Aspect 25. A system comprising: a pipeline containing carbon dioxide and an impurity; and an impurity removal unit coupled to the pipeline, wherein the impurity removal unit receives at last a portion of the carbon dioxide from a first location on the pipeline, removes the impurity or converts the impurity to a compound that can be removed by the impurity removal unit, and sends an impurity depleted carbon dioxide to a second location on the pipeline that is downstream of the first location.
Aspect 26. The system of Aspect 25, wherein the impurity removal unit is a catalyst bed for removal of a nitrogen oxide compound from the carbon dioxide, a sulfur recovery unit for removal of hydrogen sulfide from the carbon dioxide, or both the catalyst bed and the sulfur recovery unit.
Aspect 27. The method, formulation, pipeline, or system of any of Aspects 1 to 26, wherein the carbon dioxide is in a gas phase, a liquid phase, a supercritical state, or in one or more of the gas phase, liquid phase, and supercritical state.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method comprising:
introducing a formulation comprising an additive to a carbon dioxide pipeline comprising carbon dioxide,
wherein the additive comprises a dehydrating agent, an oxygen scavenger, a hydrogen sulfide scavenger, a sulfur oxides removal agent, a nitrogen oxides removal agent, or combinations thereof.

2. The method of claim 1, wherein the dehydrating agent comprises a solid desiccant, calcium chloride, phosphorus pentoxide, sodium sulfate, anhydrous magnesium sulfate, sulfuric acid, calcium oxide, barium oxide, an alkali-metal based compound, a carbodiimide-based compound, phosphorus oxychloride, phosphorous pentoxide, thionyl chloride, dimethyl sulfoxide, acetic anhydride, triethyl orthoformate, dimethylformamide, a brine, glycols, a liquid desiccant, glycerol, an alcohol-based compound, acetic acid, sugar syrup, a perchloric acid-based compound, or combinations thereof.

3. The method of claim 1, wherein the dehydrating agent is introduced as a solid phase and comprises desiccant, calcium chloride, phosphorus pentoxide, sodium sulfate, anhydrous magnesium sulfate, sulfuric acid, calcium oxide, activated alumina, barium oxide, or combinations thereof.

4. The method of claim 1, wherein the dehydrating agent is introduced as a liquid phase and comprises sulfuric acid, phosphorus oxychloride, phosphorous pentoxide, thionyl chloride, dimethyl sulfoxide, acetic anhydride, triethyl orthoformate, dimethylformamide, a brine, glycols, liquid desiccant, glycerol, an alcohol-based compound, acetic acid, sugar syrup, a carbodiimide-based compound, a perchloric acid-based compound, or combinations thereof.

5. The method of claim 1, wherein the oxygen scavenger comprises a sulfite, a phosphite, hydrazine, ascorbic acid or a derivative thereof, an iron powder, a tannin, an enzyme-based compound, sodium erythorbate, sulfur dioxide, diethyl hydroxylamine, carbohydrazide, methyl ethyl ketoxime, a copper-based compound, a phenol-containing compound, or combinations thereof.

6. The method of claim 1, wherein the hydrogen sulfide scavenger comprises a metal-based compound, nitrite-based compounds, an amine, an ammonium-based compound, caustic-based compounds, a hydrogen sulfide oxidizing agent, a triazine-based compound, a calcium hydroxide, calcium carbonate, an aldehyde-based compound, acrolein, a chelating agent-based compounds, a thiol-functionalized polymer, an ionic liquid, or combinations thereof.

7. The method of claim 1, wherein the sulfur oxides removal agent comprises lime-based compounds, sodium-based compounds, ammonia-based compounds, magnesium-based compounds, metal-oxide compounds, carbon-based materials, chelating agent-based compounds, organic amine-based compounds, catalyst-based compounds, or combinations thereof.

8. The method of claim 1, wherein the nitrogen oxides removal agent comprises metal oxide-based compounds, peroxide-based compounds, absorbents, sodium-based compounds, ammonia, urea, hydrazine, catalyst-based compounds, biological materials, or combinations thereof.

9. The method of claim 1, wherein the formulation further comprises a carrier liquid comprising an organic liquid or an inorganic liquid.

10. The method of claim 9, wherein the additive is present in the formulation in a range of from 20 wt % to 60 wt % and the carrier liquid is present in the formulation in a range of from 40 wt % to 80 wt % based on a total weight of the formulation.

11. The method of claim 9, wherein the formulation further comprises a surfactant.

12. The method of claim 11, wherein the additive is present in the formulation in a range of from 20 wt % to 60 wt %, the carrier liquid is present in the formulation in a range of from 40 wt % to 80 wt %, and the surfactant is present in a range of from greater than 0 wt % to 10 wt % based on a total weight of the formulation.

13. The method of claim 1, wherein the carbon dioxide pipeline comprises carbon dioxide and an impurity, wherein a mass ratio of the additive to the impurity after introducing is in a range of from 1:1 to 10:1 based on a mass of the additive and a mass of the impurity in the carbon dioxide that is contained in the carbon dioxide pipeline.

14. The method of claim 1, further comprising:
passing a portion of the carbon dioxide from a first location in the carbon dioxide pipeline through an impurity removal unit to form an impurity depleted carbon dioxide; and
flowing the impurity depleted carbon dioxide to a second location in the carbon dioxide pipeline, wherein the second location is downstream of the first location.

15. The method of claim 1, wherein the carbon dioxide pipeline comprises carbon dioxide and an impurity, wherein the impurity comprises water, hydrogen sulfide, oxygen, a sulfur oxide, a nitrogen oxide, or a combination thereof.

16. The method of claim 1, wherein the formulation further comprises a drag reducing agent, a pH control agent, or both.

17. A formulation comprising an additive for a carbon dioxide pipeline, wherein the additive comprises a dehydrating agent, an oxygen scavenger, a hydrogen sulfide scavenger, a sulfur oxides removal agent, a nitrogen oxides removal agent, or combinations thereof.

18. The formulation of claim 17, further comprising a carrier liquid, a surfactant, a drag reducing agent, a pH control agent, or combinations thereof.

19. A carbon dioxide pipeline comprising:
a pipeline;
carbon dioxide contained in the pipeline; and
a formulation comprising an additive for the carbon dioxide contained in the pipeline, wherein the additive comprises a dehydrating agent, an oxygen scavenger, a hydrogen sulfide scavenger, a sulfur oxides removal agent, a nitrogen oxides removal agent, or combinations thereof.

20. A system comprising:
a pipeline containing carbon dioxide and an impurity; and
an impurity removal unit coupled to the pipeline, wherein the impurity removal unit receives at last a portion of the carbon dioxide from a first location on the pipeline, removes the impurity or converts the impurity to a compound that can be removed by the impurity removal unit, and sends an impurity depleted carbon dioxide to a second location on the pipeline that is downstream of the first location.
